(19) United States
(12) Patent Application Publication
(10) Pub. No.: US 2007/0237280 A1
(43) Pub. Date: Oct. 11, 2007

(54) Electromagnetic confinement configuration for plasma stabilization

(76) Inventor: Claude Bouillon, Sainte-Foy (CA)

Correspondence Address: BIRCH STEWART KOLASCH & BIRCH, PO BOX 747, FALLS CHURCH, VA, 22040-0747, US

(21) Appl. No.: 11/705,776

(22) Filed: Feb. 14, 2007

Related U.S. Application Data
(60) Provisional application No. 60/772,905, filed on Feb. 14, 2006.

(51) Int. Cl. G21B 1/00

(52) U.S. Cl. 376/121

(57) ABSTRACT

A magnetic confinement arrangement for confining plasma in a fusion reactor. The confinement arrangement comprises fixed coils disposed around and equidistantly distributed along an outer surface of a confinement chamber in a toroidal configuration, and pairs of overlapping pivotable coils equidistantly distributed along the outer surface of the confinement chamber. Each coil of the pairs is disposed around the outer surface in a substantially toroidal configuration. The pivotable coils a same pair are mounted about a common pivot axis transverse to a channel of the confinement chamber. The fixed coils produce a primary confinement of the plasma and the pivotable coils produce a secondary confinement of the plasma which is adjustable by varying an angle between the pivotable coils of a given pair.

This Nonprovisional application claims priority under 35 U.S.C. § 119(e) on U.S. Provisional Application No. 60/772,905 filed on Feb. 14, 2006, the entire contents of which are hereby incorporated by reference.

### BACKGROUND OF THE INVENTION

1) Field of the Invention

The invention relates to thermonuclear fusion reactors. More particularly, this invention relates to magnetic confinement of plasma in a thermonuclear fusion reactor.

2) Description of the Prior Art

As opposed to nuclear fission, in a thermonuclear fusion reaction, energy is produced by a powerful exothermic reaction in which atoms are combined to produce lower energy atoms. But in order to produce the nuclear fusion reaction, difficult high temperature and high pressure conditions must be met. The nuclear fusion reaction requires high temperatures to which the atoms to be fused (typically hydrogen, deuterium and tritium) are in the plasma phase. Only at these high temperatures will the electrical repulsion between the atoms be sufficiently inhibited for the nuclear fusion reaction to occur. Furthermore, high pressure is required to increase the rate of collisions between atoms of plasma for the nuclear fusion reaction to occur.

One way of achieving the required high pressure is by magnetic confinement of plasma. One magnetic confinement configuration is the electromagnetic toroidal configuration which provides an endless circular magnetic field. The Tokamak is an example of a toroid nuclear fusion reactor producing a toroidal magnetic field to confine plasma in the reactor chamber. However, as electrical windings are inevitably looser on the outside surface of the toroid than on the inside surface, the magnetic force is non-uniform on the cross-section of the toroid. Consequently, a separation of the electrical charges of the non-centered particles of plasma occurs. The positive and negative ions diffuse in opposite directions toward the outside of the chamber. The efficiency of the fusion reaction is consequently limited by the low confinement of plasma.

The Stellarator is a nuclear fusion reactor designed to confine plasma using magnetic fields in order to produce a fusion reaction. In order to reduce the separation of electrical charges, the Stellarator uses a confinement chamber having a figure-eight shape instead of a toroidal shape. In the Stellarator, positive and negative ions still diffuse in opposite directions but, due to the figure-eight shape, particles travel alternately in the outside region and in the inside region of the confinement chamber. However, it is difficult to achieve a perfectly balanced travel of particles between the inside and the outside regions.

None of the above-mentioned configurations provide sufficient plasma confinement to achieve a positively balanced nuclear fusion reaction.

### SUMMARY OF THE INVENTION

There is described herein an electromagnetic confinement configuration which improves the confinement of plasma to eventually achieve a nuclear fusion reaction.

The proposed electromagnetic confinement configuration provides an adaptable magnetic field configuration that can be varied throughout the nuclear fusion reaction process.

A magnetic confinement configuration for confining plasma in a fusion reactor is provided. The magnetic confinement configuration comprises a primary toroidal electromagnetic coil arrangement for magnetic confinement of the plasma. The primary toroidal electromagnetic coil arrangement is similar to the magnetic coil arrangement of known thermonuclear fusion reactors such as the Tokamak. In addition to the primary toroidal electromagnetic coil arrangement, a secondary electromagnetic coil arrangement is provided. The secondary arrangement comprises pairs of pivotable coils distributed along the confinement chamber of the fusion reactor. The angle between the pivotable coils of each pair can be varied. The angle between the coils of each pair is increased for confining and stabilizing the plasma, which increases the chances of fusion reaction in the plasma.

In accordance with a first broad aspect of the present invention, there is provided a magnetic confinement arrangement for confining plasma in a fusion reactor having a confinement chamber for receiving the plasma, the confinement arrangement comprising: fixed coils disposed around and equidistantly distributed along an outer surface of the confinement chamber in a toroidal configuration, for producing a primary confinement of the plasma; and pairs of overlapping pivotable coils equidistantly distributed along an outer surface of the channel, each coil of the pairs being disposed around the outer surface in a substantially toroidal configuration, the pivotable coils of a same pair being mounted about a same pivot axis transverse to a channel of the confinement chamber, for producing a secondary confinement of the plasma, the secondary confinement being adjustable by varying an angle between the pivotable coils of a given pair.

In accordance with a second broad aspect of the present invention, there is provided a fusion reactor comprising: a confinement chamber having an endless channel for receiving plasma; fixed coils disposed around and distributed along an outer surface of the confinement chamber in a toroidal configuration for producing a primary confinement of the plasma; and pairs of pivotable coils distributed along an outer surface of the confinement chamber, each of the coils being disposed around the outer surface, the pairs being mounted about corresponding pivot axes intersecting the channel substantially along a cross-section of the channel, the pairs for producing a secondary confinement of the plasma, the secondary confinement being adjustable by varying an angle between the each one of the pivotable coils in a given pair.

In accordance with a third broad aspect of the present invention, there is provided a method for confining plasma, the method comprising: distributing fixed coils along an outer surface of a substantially doughnut-shaped confinement chamber in a substantially toroidal configuration; distributing pairs of overlapping pivotable coils along the outer surface in a substantially toroidal configuration; energizing at least part of the fixed coils in order to produce a magnetic field having endless magnetic field lines; energizing the pairs of overlapping pivotable coils; providing a plasma of ionized particle mixture in the confinement chamber; and increasing an angle between the pivotable coils of each one of the pairs by pivoting the pivotable coils symmetrically about a pivot axis transverse to the confinement chamber to confine the plasma.

### BRIEF DESCRIPTION OF THE DRAWINGS

Further features and advantages of the present invention will become apparent from the following detailed description, taken in combination with the appended drawings, in which:

FIG. 1 is a top plan view of an electromagnetic confinement configuration according to one example embodiment of the invention;

FIG. 2 is a partial perspective view of the electromagnetic confinement configuration of FIG. 1;

FIG. 3 is a partial top plan view of the electromagnetic confinement configuration of FIG. 1;

FIG. 4 is a partial cross-sectional view of the electromagnetic confinement configuration of FIG. 1 and taken along the plane 4-4 of FIG. 3;

FIG. 5 is a partial cross-sectional view of the electromagnetic confinement configuration of FIG. 1 and taken along the plane 5-5 of FIG. 4; and

FIG. 6 is a partial cross-sectional view of the electromagnetic confinement configuration of FIG. 1 and taken along the plane 5-5 of FIG. 4 and illustrating the magnetic field produced by, the fixed and pivotable coils of the magnetic configuration confining the plasma.

It will be noted that throughout the appended drawings, like features are identified by like reference numerals.

### DETAILED DESCRIPTION OF THE INVENTION

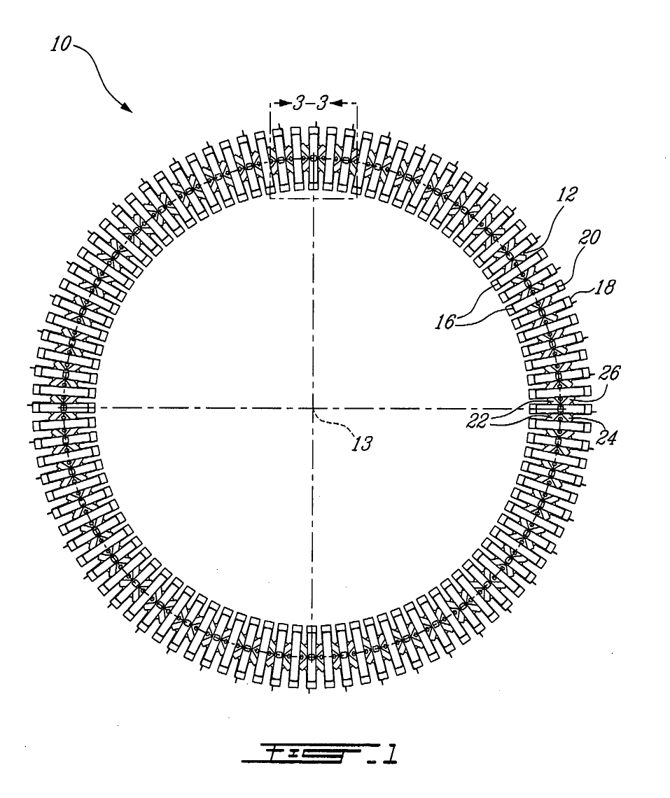

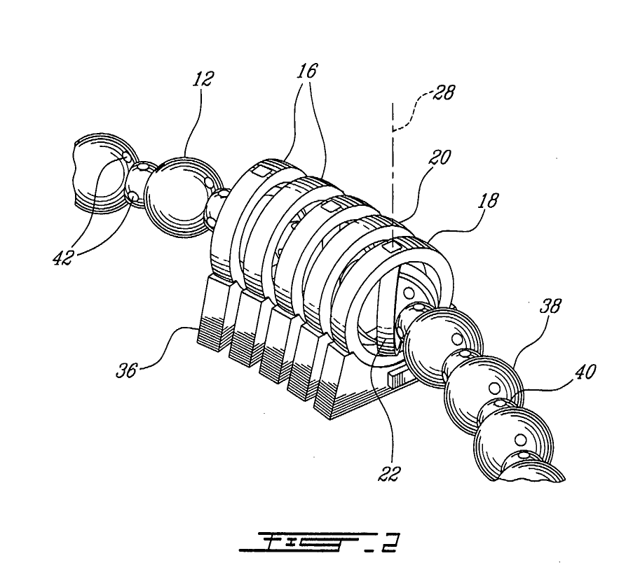

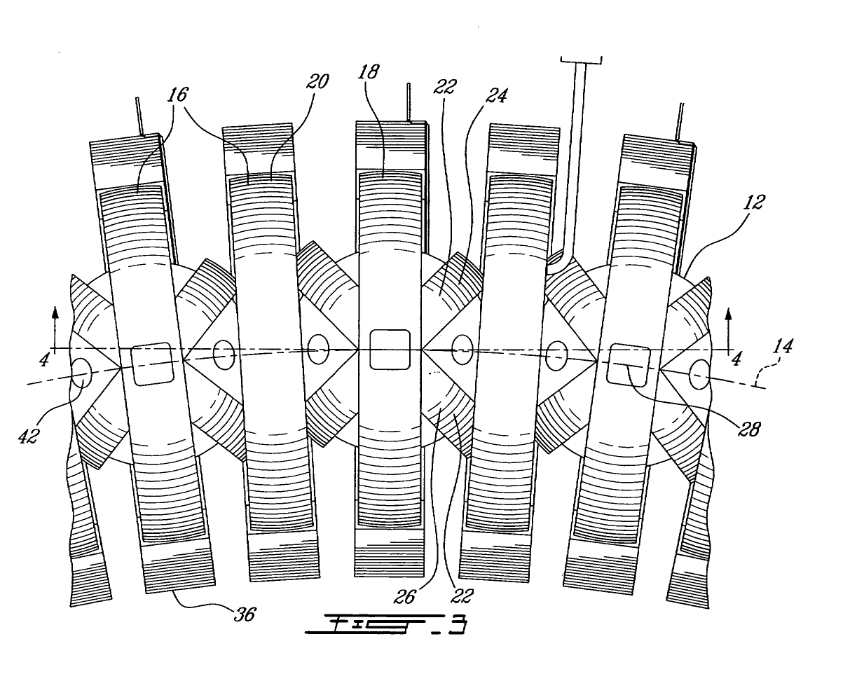

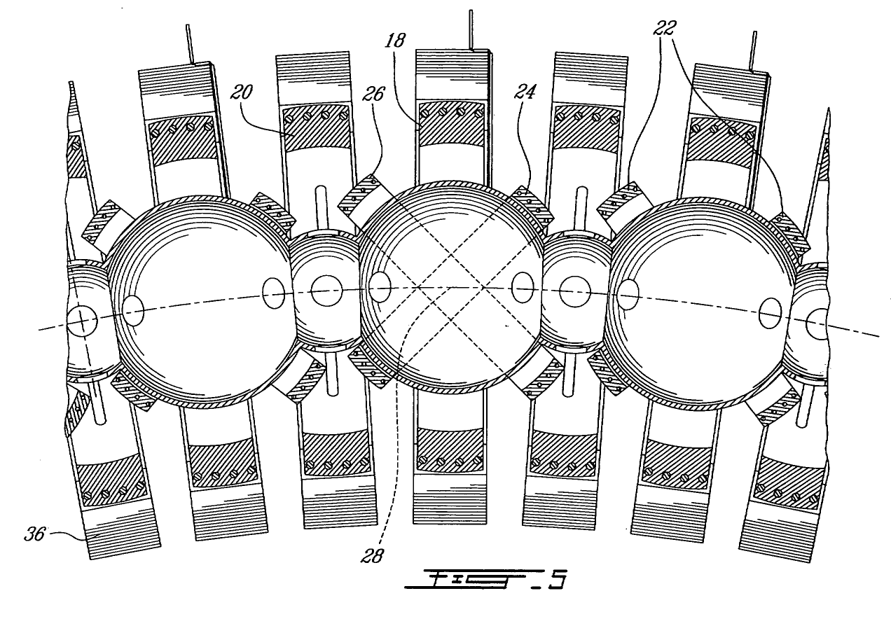

FIGS. 1 to 5 show the electromagnetic confinement arrangement 10 used in a fusion reactor in order to confine and stabilize plasma and increase the chances that a nuclear fusion reaction occurs. The fusion reactor 10 comprises a confinement chamber 12 in the shape of an endless channel. As is more clearly illustrated in FIG. 2, the cross-section of the channel varies along the confinement chamber to define successive rounded hollow spaces in the shape of a strand of pearls having alternating large and small substantially round and overlapping hollow spaces, i.e. large pearls 38 and small pearls 40. The confinement chamber 12 has a central axis 13 (see FIG. 1) and a channel cross-section, i.e. the cross-section of the channel defining the confinement chamber 12.

The confinement arrangement 10 comprises ninety-six fixed electrical conductor coils 16 equidistantly distributed along the confinement chamber 12 with a one-foot distance between the central points of the fixed coils. The fixed coils 16 comprise forty-eight collection coils 18 and forty-eight magnetic field coils 20. Collection coils 18 and magnetic field coils 20 alternate along the confinement chamber 12. The fixed coils 16 are located outside the confinement chamber 12. Applying direct electric current to the magnetic field coils 20 creates a toroidal field in the confinement chamber. The confinement chamber 12 and the fixed coils 16 are constructed using materials and techniques as known in the art.

A pair of independently mechanically pivotable electrical conductor coils 22 is associated with each one of the collection coils 18, for a total of forty-eight pairs of pivotable coils 22. Each pair of pivotable coils 22 is aligned with one collection coil 18 and has a diameter that is smaller than the diameter of the collection coil 18 so it is located within the collection coil 18 and outside the confinement chamber 12. Each pair of pivotable coils 22 comprises an inner pivotable coil 24 and an outer pivotable coil 26. The inner and the outer pivotable coils 24, 26 of a same pair are independently pivotable about the same pivot axis 28 (see FIG. 2). The pivot axis 28 is transverse to the channel defining the confinement chamber, i.e. it intersects the channel along the cross-section of the channel, in parallel with the central axis 13 of the confinement chamber 12. More specifically, it is transverse to one of the large pearls 38 such that, as the inner and outer pivotable coils 24, 26 pivot, they follow the outer surface of a large pearl 38. At a rest position, the inner and the outer pivotable coils 24, 26 are aligned with the collection coils 18. A mechanical actuator (not shown) actuates the inner and outer pivotable coils 24, 26 to symmetrically pivot around the pivot axis 28 in order to create an angle between the inner and outer pivotable coils 24, 26. In FIGS. 1 to 6, the pivotable coils 24, 26 are shown with an angle of ninety degrees. The diameter of the inner and the outer pivotable coils 24, 26 and the diameter of the alternating large and small pearls 38, 40 are such that the inner and the outer pivotable coils 24, 26 can open to reach an angle of ninety degrees without interfering with the confinement chamber 12. All pairs of pivotable coils 22 are rotated simultaneously so that the angle defined by each pair is the same when the fusion reactor 10 is active.

As shown in FIG. 2, the confinement chamber 12, the fixed coils 16 and the pivotable coils 22 are mounted using a support body 36 to which these parts are attached. The confinement chamber 12 has a gas inlet 34 in order to introduce an ionized gas consisting of a mixture of deuterium and tritium to eventually provide the plasma. Each small and large pearl 38, 40 of the confinement chamber 12 includes four waveguides 42 for guiding microwaves in the confinement chamber in order to heat the ionized gas introduced in the confinement chamber 12.

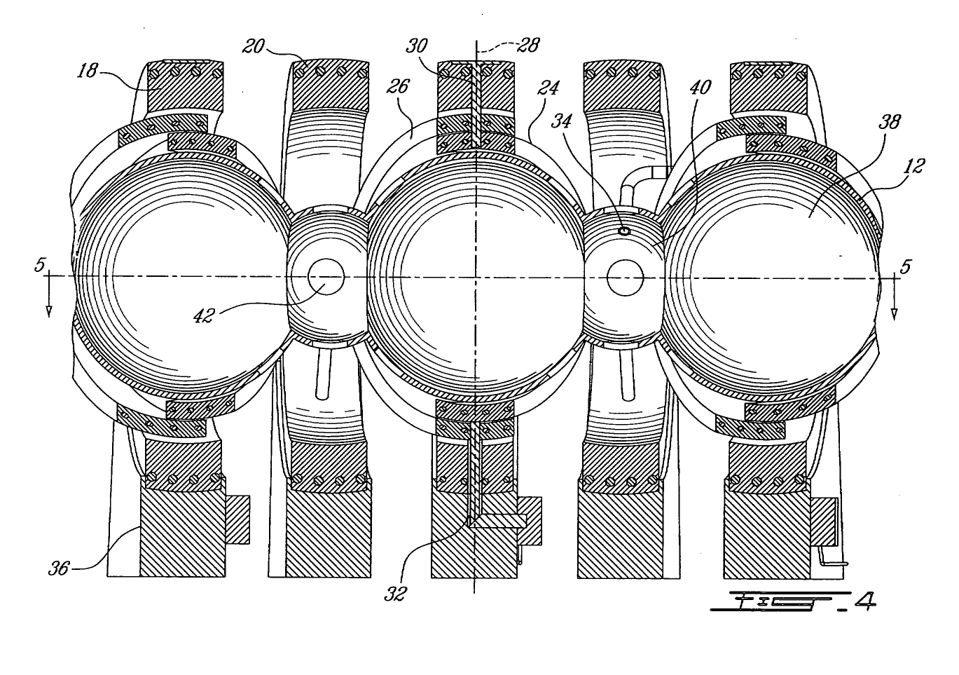

As shown in FIG. 4, a mechanical actuator (not shown) actuates each pair of inner and outer pivotable coils 24, 26 so that they symmetrically pivot about the pivot axis 28. Each mechanical actuator has an electrical motor connected to a bottom double pivot mechanism 32 connected to the inner and the outer pivotable coils 24, 26, to actuate them in opposite directions using a single mechanical actuator. The forty-eight motors are typically computer controlled or are controlled by an operator of the fusion reactor. The electrical motor actuates one of the inner and the outer pivotable coils 24, 26 which cause the other pivotable coil to pivot in the opposite direction through gears or any other double pivot mechanism 22. A top swivel pivot 30 is provided to guide the inner and outer pivotable coils 24, 26 about the pivot axis 28 as it is activated from the bottom double pivot mechanism 32.

The fusion reactor is adapted to operate by following sequential steps leading up to the nuclear fusion of particles of deuterium and tritium in the confinement chamber 12. The pairs of pivotable coils 22 are used along with the magnetic field coils 20 and the collection coils 18 for confining the plasma. First, an ionized particle mixture of deuterium and tritium is provided in the confinement chamber 12 using the gas inlet 34. Then, the temperature of the mixture is increased using techniques known in the art. The temperature obtained is high enough to sufficiently inhibit the atomic repulsion for the nuclear reaction to be allowed. For this purpose, microwaves can be provided in the confinement chamber 12 using waveguides 42. At the obtained temperature, the atoms to be fused are in a plasma phase.

Furthermore, high pressure is required to increase the rate of collisions between atoms of plasma for the nuclear fusion reaction to occur. A primary magnetic confinement of the plasma is obtained by energizing the fixed coils 16, i.e. both magnetic field coils 20 and collection coils 18 at this time. The pairs of pivotable coils 22 are in a resting position, i.e. the inner and the outer pivotable coils 24, 26 are aligned. The pivotable coils 22 are also energized.

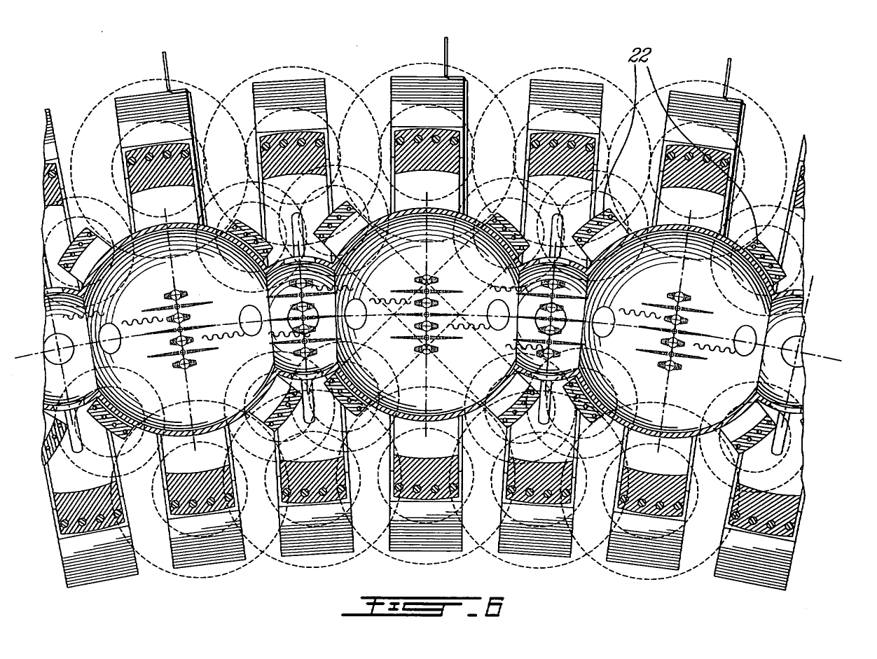

The fusion reaction is initiated by symmetrically increasing the angle between the inner and the outer pivotable coils 24, 26. The angle between the inner and the outer pivotable coils 24, 26 is gradually and smoothly increased until it reaches ninety degrees to smoothly confine and stabilize the plasma. The particles are then confined by the magnetic field structure created by the inner and outer pivotable coils 24, 26 and the fixed coils 16, and a back and forth motion of the particles initiates inside the magnetic structure. FIG. 6 illustrates the location in the confinement chamber 12 where the back and forth motion of the particles takes place, i.e. within the large and the small pearls 38,40. As shown in FIG. 6, the magnetic field produced by the pivotable coils 24, 25 and the fixed coils 16 creates an alcove bounded by convex magnetic fields (dashed lines) that enclose and confine the plasma in each of the large and the small pearls 38,40. The plasma is more easily stabilized in the alcoves which provide a local stabilization of the plasma instead of a global stabilization along a quite long toroidal configuration. Vibrations of the particles due to the very high temperature and the electromagnetic force between the highly energetic particles cause the particles to vibrate in the alcoves in an energetic back and forth motion which increases the rate of collisions among the particles. Nuclear fusion is thereby likely to occur. The back and forth motion also generates heat and microwaves (illustrated as small sinusoidal lines) which contribute to increase the temperature of the plasma and thus to nuclear fusion.

As the fusion reaction occurs, the plasma circulates along the confinement chamber 12 and the nuclear fusion reaction is maintained by the high level of energy that is produced.

The collection coils 18 are no longer needed to maintain the fusion reaction and can be used to collect the energy by induction of a powerful electrical current in the collection coils 18.

For security reasons, the fusion experiments should begin with a small density of particles of about 10¹⁵ to 10¹⁸ particles per cubic centimeters. It is also to be noted that the deuterium-tritium mixture are be ionized to approximately 0.1 MeV so that the deuterium and tritium particles have sufficient energy to overcome the repulsive electrostatic force between the two nuclei to fuse. The released energy is sufficient to achieve a positive balance. During the entire operation of the fusion reactor 10, the pairs of pivotable coils 22 are energized to produce a magnetic flux density of about two to seven Tesla, and to circulate the plasma, the magnetic field coils 20 and the collection coils 18 are also energized to produce a magnetic flux density of two to seven Tesla.

It is noted that the collection coils 18 may not be used for magnetic confinement. Alternatively, more power may be provided to the magnetic field coils 20 for magnetic confinement. In another alternative, the collection coils 18 can also be energized during the fusion reaction so that more energy is provided to circulate the plasma.

In an alternative embodiment, an external heat source can be used before the particle mixture is introduced in the confinement chamber 12 to preheat the particles.

The collection coils 18 and the magnetic field coils 20 are similarly constructed and they can be interchanged so that the magnetic field coils 20 collect the energy produced by the fusion reaction and the collection coils 18 provide a magnetic field to circulate the plasma along the confinement chamber 12.

Alternatively to the above described operation of the fusion reactor 10, the angle between the inner and outer pivotable coils 24, 26 can be varied among a number of predetermined possible angles so that the plasma is smoothly confined.

As described above, during the sequential operation of the fusion reactor, the angle between the inner and the outer pivotable coils is gradually opened until it reaches ninety degrees. One should understand that another angle can alternatively be chosen.

One skilled in the art will understand that the energy produced by the nuclear reaction in the form of heat can be collected using a heat exchanger and turbine generator.

It is appreciated that the pivot axis, herein described as being transverse to the channel defining the confinement chamber 12 and parallel to the revolution axis of the confinement chamber 12, can alternatively define any angle with the central axis 13 of the confinement chamber 12, provided it is transverse to the channel defining the confinement chamber 12. As an example, the pivot axis can be perpendicular to the central axis 13 instead of being parallel.

Also, in the described embodiment, the number of fixed coils is ninety-six and the number of pairs of pivotable coils is forty-eight. It should be understood that these numbers are arbitrary. The number of pairs of pivotable coils can be any arbitrary number.

In the particular embodiment illustrated herein, the pairs of pivotable coils comprise inner and outer coils so that the two coils can pivot independently. It should be understood that the two coils can have the same or different diameters and have varying shapes so that they can pivot independently with no mechanical interference.

Furthermore, in the described embodiment, the confinement chamber is constituted of overlapping round hollow spaces forming a strand of pearls arrangement. Alternatively, the confinement chamber 12 can be in the shape of a toroid but the volume of the confinement chamber 12 is then consequently be reduced in order to allow the pivotable coils 24, 26 to pivot to a ninety-degree position with respect to one another.

The embodiments of the invention described above are intended to be exemplary only. The scope of the invention is therefore intended to be limited solely by the scope of the appended claims.

What is claimed is:

1. A magnetic confinement arrangement for confining plasma in a fusion reactor having a confinement chamber for receiving said plasma, the confinement arrangement comprising:
fixed coils disposed around and equidistantly distributed along an outer surface of said confinement chamber in a toroidal configuration, for producing a primary confinement of said plasma; and
pairs of overlapping pivotable coils equidistantly distributed along said outer surface, each coil of said pairs being disposed around said outer surface in a substantially toroidal configuration, pivotable coils of a same one of said pairs being mounted about a common pivot axis transverse to a channel defining said confinement chamber, for producing a secondary confinement of said plasma, said secondary confinement being adjustable by varying an angle between said pivotable coils of a given pair.

2. The magnetic confinement arrangement as claimed in claim 1, wherein a number of said fixed coils is equal to twice a number of said pairs.

3. The magnetic confinement arrangement as claimed in claim 2, wherein said pivot axis of each one of said pairs is aligned with one of said fixed coils.

4. The magnetic confinement arrangement as claimed in claim 2, wherein said number of said pairs is forty-eight.

5. The magnetic confinement arrangement as claimed in claim 4, wherein a center of adjacent pairs of said pivotable coils are spaced substantially two feet apart.

6. The magnetic confinement arrangement as claimed in claim 1, wherein a diameter of each one of said coils of said pairs is smaller than a diameter of said fixed coils, each one of said coils of said pairs being located inside one of said fixed coils.

7. The magnetic confinement arrangement as claimed in claim 1, wherein a diameter of one coil of a given pair of coils is smaller than a diameter of another coil of said given pair of coils, said one coil of a given pair being located inside said another coil of said given pair.

8. The magnetic confinement arrangement as claimed in claim 1, wherein the pivot axis is parallel to a central axis of the confinement chamber.

9. A fusion reactor comprising:
a confinement chamber having an endless channel for receiving plasma;
fixed coils disposed around and distributed along an outer surface of said confinement chamber in a toroidal configuration for producing a primary confinement of said plasma; and
pairs of pivotable coils distributed along an outer surface of said confinement chamber, each one of said coils being disposed around said outer surface, said pairs being mounted about corresponding pivot axes intersecting said channel substantially along a cross-section of said channel, said pairs for producing a secondary confinement of said plasma, said secondary confinement being adjustable by varying an angle between said each one of said pivotable coils in a given pair.

10. The fusion reactor as claimed in claim 9, wherein the confinement chamber is shaped as a strand of pearls and defines a plurality of successive rounded hollow spaces, and each one of said pairs is mounted around one of said hollow spaces such that said pivotable coils of each one of said pairs are pivotable partly around one of said hollow spaces.

11. The fusion reactor as claimed in claim 9, wherein said confinement chamber comprises a gas inlet for introducing an ionized gas of deuterium and tritium to provide said plasma.

12. The fusion reactor as claimed in claim 11, wherein said confinement chamber comprises waveguides for guiding microwaves in said confinement chamber for heating said ionized gas.

13. A method for confining plasma, the method comprising:
distributing fixed coils along an outer surface of a substantially doughnut-shaped confinement chamber, in a substantially toroidal configuration;
distributing pairs of overlapping pivotable coils along said outer surface in a substantially toroidal configuration;
energizing at least part of said fixed coils in order to produce a magnetic field having endless magnetic field lines;
energizing said pairs of overlapping pivotable coils; and
providing a plasma of ionized particle mixture in said confinement chamber;
increasing an angle between said pivotable coils of each one of said pairs by pivoting said pivotable coils symmetrically about a pivot axis transverse to said confinement chamber to confine said plasma.

14. The method as claimed in claim 13, wherein said increasing an angle comprises increasing said angle to ninety degrees.

15. The method as claimed in claim 13, wherein said providing a plasma comprises inserting said ionized particle mixture in said confinement chamber; and heating said ionized particle mixture.
